(19) United States
(12) Patent Application Publication
(10) Pub. No.: US 2015/0127686 A1
(43) Pub. Date: May 7, 2015

(54) EXPERIENCE INFORMATION MANAGING APPARATUS AND METHOD THEREOF

(71) Applicant: HYUNDAI MOTOR COMPANY, Seoul (KR)

(72) Inventors: Chul Min Kim, Suwon (KR); Dong Youl Lee, Seoul (KR)

(73) Assignee: HYUNDAI MOTOR COMPANY, Seoul (KR)

(21) Appl. No.: 14/288,901

(22) Filed: May 28, 2014

(30) Foreign Application Priority Data
Nov. 5, 2013 (KR) 10-2013-0133429

(51) Int. Cl. G06F 17/30

(52) U.S. Cl. CPC G06F 17/30115
USPC 707/803

(57) ABSTRACT

An experience information managing apparatus is provided. In particular, a processor is configured to interpret structures of first and second UCX files when the first UCX file and the second UCX file have a file format that are different from each other. The processor then tags information indicating a source to data forming the first and second UCX files and creates combination information of the first and second UCX files. A third UCX file is then created by the processor having the first and second UCX files combined therewith according to the combination information.

### CROSS REFERENCE

This application is based on and claims priority from Korean Patent Application No. 10-2013-0133429, filed on Nov. 5, 2013 in the Korean Intellectual Property Office, the disclosure of which is incorporated herein in its entirety by reference.

### BACKGROUND OF THE INVENTION

1. Field of the invention

The present invention relates to an experience information managing apparatus for a driver and a method thereof, and more particularly, to a technology of organically combining vehicle operation information from the driver and output information of the vehicle and managing the combined information in a content file.

2. Description of the Prior Art

In general, even though a vehicle may be the same or a similar model, may develop different unique characteristics depending on a driving pattern, a propensity, and the like of a driver. For example, the wearing of parts, the learning logic of a controller, the life of exchanging articles of consumption, fuel efficiency, and the like of the vehicle are products of each individual driver's driving habits

The driving pattern and habit of an individual driver may influence economical driving and safe driving as well as driving of other vehicles, which is an important factor, different experience information is maintained according to a relationship between the driver and the vehicle, and this experience information may be exploited in various fields.

Accordingly, this experience information described above should be generated for each driver and each vehicle, and therefore it is difficult to manage information for this large amount of data and to reflect any changes in the information in real time.

In addition, each different piece of information may have a different file format depending on its intended purposes. Therefore, a separate file format is often required in order to generate a new type of experience information that combines a plurality of experience information, and a new type of plug-in for interpreting and generating the new file format is needed to be developed. Therefore, a method capable of easily combining the plurality of experience information for a general purpose user is required.

### SUMMARY OF THE INVENTION

Accordingly, the present invention has been made to solve the above-mentioned problems occurring in the prior art while advantages achieved by the prior art are maintained. One object to be achieved by the present invention is to provide an experience information managing apparatus combines and utilizes experience information having file formats different from each other without developing a separate file format or plug-in, and a method thereof.

In one aspect of the present invention, there is provided an experience information managing apparatus, including: a user created experience (UCX) interpreter configured to interpret structures of first and second UCX files when the first UCX file and the second UCX file having a file format different from that of the first UCX file are input therein. Also included is a UCX combiner configured to tag information indicating a source to data forming the first and second UCX files and create combination information of the first and second UCX files. A UCX creator is configured to create a third UCX file having the first and second UCX files combined therewith according to the combination information.

The UCX files may be content files having a metadata media embodied as the experience information of a driver and a vehicle created by combining manipulation data of the vehicle by the driver and data obtained from the vehicle and around the vehicle in response to manipulation data. As such, these UCX files may be prepared with a meta script language.

The apparatus may further include a communication interface configured to receive first and second UCX interpreting plug-ins implementing an interpreting algorithm for a data structure of each of the first and second UCX files. This UCX interpreter may interpret the structures of the first and second UCX files using the first and second UCX interpreting plug-ins.

The UCX combiner may combine the first and second UCX files by directly inserting data forming the first UCX file into the second UCX file or inserting identification information of data forming the first UCX file into the second UCX file.

The apparatus may further include a communication interface configured to receive first and second UCX creating plug-ins implementing a file creating algorithm for each of the first and second UCX files. The UCX creator may then create a new UCX file using the first and second UCX creating plug-ins.

In another aspect of the present invention, there is provided an experience information managing method, including: interpreting, by a processor, structures of first and second user created experience (UCX) files when the first UCX file and the second UCX file having a file format different from that of the first UCX file are input; tagging, by the processor, information indicating a source to data forming the first and second UCX files; creating, by the processor, combination information of the first and second UCX files; and creating, by the processor, a third UCX file having the first and second UCX files combined therewith according to the combination information.

Additionally, in some exemplary embodiments, interpreting of the structures may include:

receiving, by the processor, first and second UCX interpreting plug-ins implementing an interpreting algorithm for a data structure of each of the first and second UCX files; and interpreting the structure of each of the first and second UCX files using the first and second UCX interpreting plug-ins.

The creation of the third UCX file may include: receiving, by the processor, first and second UCX creating plug-ins implementing a file creating algorithm for each of the first and second UCX files using the tagging information; and creating, by the processor, a new UCX file using the first and second UCX creating plug-ins.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a driver's experience information managing system according to an exemplary embodiment of the present invention;

FIG. 2 is a block diagram showing a configuration of an experience information managing apparatus according to an exemplary embodiment of the present invention;

FIG. 3 is a view for describing a structure of a UCX schema according to an exemplary embodiment of the present invention;

FIGS. 4 to 6 are views for describing a combined form of UCX files according to an exemplary embodiment of the present invention;

FIGS. 7A to 7C are views for describing combined forms of UCX files according to another exemplary embodiment of the present invention; and

FIG. 8 is a flow chart for describing an experience information managing method according to an exemplary embodiment of the present invention.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

Additionally, it is understood that the below methods are executed by at least one processor which controls for example, a vehicle data collector, a UCX interpreter, a UCX combiner, a UCX creator, a UCX editor, etc. The term processor refers to a hardware device configured to execute one or more steps that should be interpreted as its algorithmic structure. The processor interacts with memory that is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, the present invention will be described in detail with reference to the accompanying drawings.

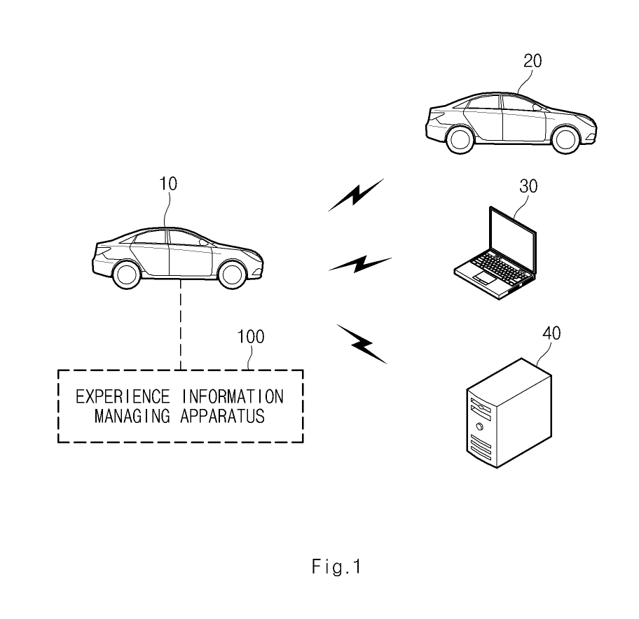

FIG. 1 is a view showing a driver's experience information managing system according to an exemplary embodiment of the present invention. Referring to FIG. 1, the driver's experience information managing system may include an experience information managing apparatus 100 included in a vehicle, and other vehicles 20, a terminal apparatus 30, and a server 40 each which are connected to the experience information managing apparatus through a network.

The driver's experience information managing apparatus 100 may create a content file by collecting experience information of a driver and a vehicle (for example, manipulation data of the driver and data obtained from the vehicle or around the vehicle in response to manipulation data). In addition, the driver's experience information managing apparatus 100 may edit and utilize the created content file, and may create a new content file by combining a plurality of content files.

Here, the content file for experience information is a file having a meta-media form (i.e., metadata), may be prepared with meta script language, for example, an extensible markup language (XML), and the creation and the edition is thus easy, thereby making it possible to conveniently mange the file.

Hereinafter, experience information refers to as ‘user created experience (UCX)’ and the content file refers to a ‘UCX file’ for convenience of explanation. The experience information managing apparatus 100 classifies obtained experience information according to time, location, and relationship and organically combines each of classified data, thereby making it possible to create at least one UCX file.

The experience information managing apparatus 100 may share the content file for experience information for the driver and the vehicle with other sharing devices through a communication interface. Specifically, the experience information managing apparatus may transmit and receive the content file by communicating with other vehicles 20, the terminal apparatus 30, the server 40, and the like.

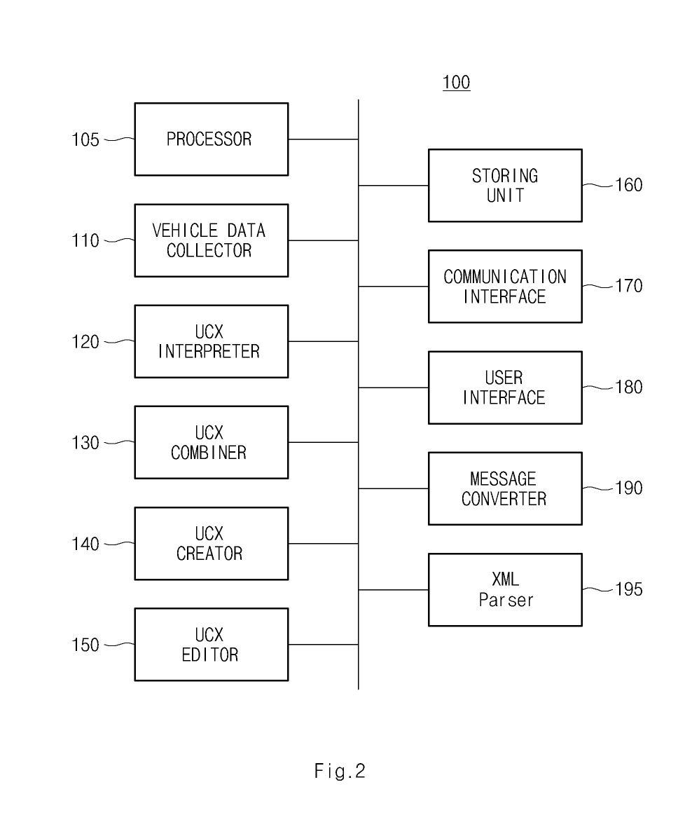

FIG. 2 is a block diagram showing a configuration of an experience information managing apparatus according to an exemplary embodiment of the present invention. Referring to FIG. 2, the experience information managing apparatus may include a vehicle data collector 110, a UCX interpreter 120, a UCX combiner 130, a UCX creator 140, a UCX editor 150, a storing unit 160, a communication interface 170, a user interface 180, a message converter 190, and an XML parser 195 all of which may be executed and controlled by a processor 105.

The vehicle data collector 110 collects input and output data of the respective units included in the vehicle and collects data obtained around the vehicle. Particularly, the vehicle data collector 110 collects manipulation data of the vehicle by the driver and output data corresponding to manipulation data, for example, raw data obtained from a power train, a chassis, a multimedia device, various sensors, and vehicle material.

The UCX interpreter 120 is configured to interpret a UCX file. Specifically, the UCX interpreter 120 may interpret a structure of the UCX file, for example whether the UCX file is made up of any data block and any data, or whether it is combined with other UCX files.

When the UCX file is input, the UCX interpreter 120 may request a UCX interpreting plug-in to outside the system 100 through the communication interface 170 and may interpret the UCX file using the UCX interpreting plug-in. The UCX interpreting plug-in may be installed and removed as an application module implementing an interpreting algorithm for the data structure of the UCX file.

The UCX file may have each UCX schema depending on its purpose, and the UCX interpreting plug-in may be separately present according to the UCX schema. Therefore, the UCX interpreter 120 may check the UCX schema of the UCX file to be interpreted and request the UCX interpreting plug-in corresponding to the checked UCX schema. The UCX schema refers to a file format for creating the UCX file. The UCX schema may be separately defined depending on the purpose of the UCX file (for example, user experience relating to a safety driving, user experience relating to an economical driving, and the like).

When the plurality of UCX files having different file formats are input, the UCX interpreter 120 may check the UCX schema of each of the plurality of UCX files and each request the UCX interpreting plug-in corresponding to the plurality of UCX files.

When the UCX file having a form in which the plurality of UCX files are combined is input, the UCX interpreter 120 may check information indicating sources tagged to the respective data blocks or data included in the combined UCX file and may request the UCX interpreting plug-in corresponding to the respective UCX files. Information indicating the sources tagged to the data blocks or data informs that the corresponding data block or data has any UCX scheme and therefore, any UCX interpreting plug-in may be selected.

Meanwhile, the UCX interpreter 120 may provide the interpreted result of the UCX file to the UCX combiner 130, the UCX editor 150, and the message converter 190 depending on the purpose of the interpreted result (for example, the purpose for editing, combining, or playing the UCX file). The UCX combiner 130 receives the interpreted results for the plurality of UCX files from the UCX interpreter 120 and creates combined information of the plurality of UCX files. As such, the plurality of UCX files may have file formats different from each other. That is, the plurality of UCX files may be the UCX files created based on the UCX schemas different from each other.

Here, combined information is information indicating a combined state or a combined structure of the plurality of UCX files. For example, the combined information may define a main UCX file and a sub UCX file and may include information such as any data (or data block) of the sub UCX file that is combined with any data block of the main UCX file. The UCX combiner 130 may create combined information according to a preset combination rule or user instructions input through the user interface 180.

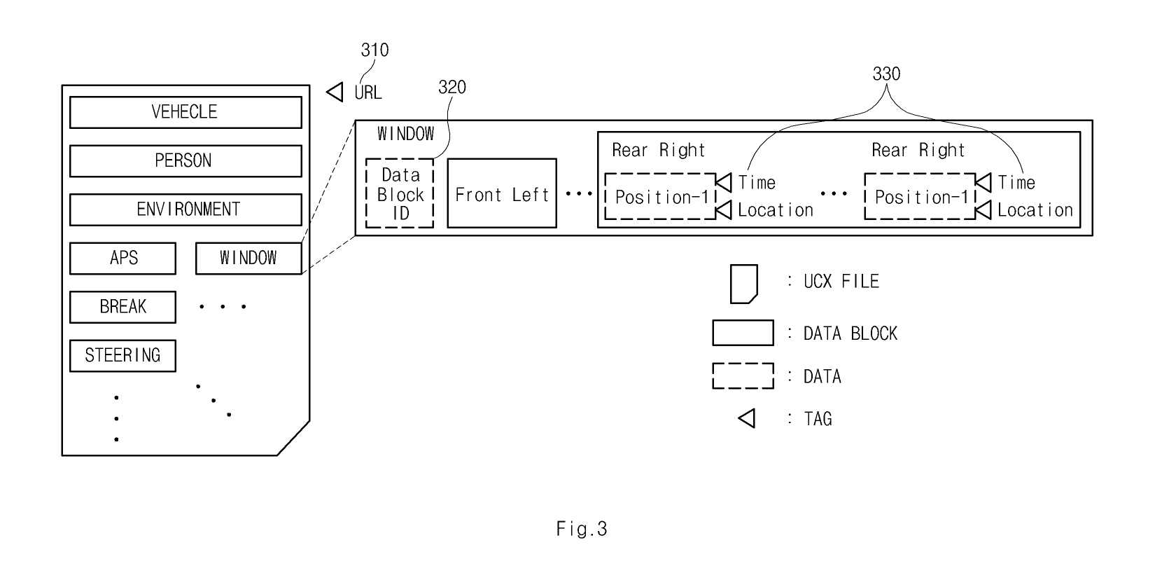

Meanwhile, in order to combine the UCX file, the UCX schema needs to be defined as a combinable structure. Hereinafter, a structure of a combinable UCX schema will be described in detail with reference to FIG. 3.

FIG. 3 is a view for describing a structure of a UCX schema according to an exemplary embodiment of the present invention. Referring to FIG. 3, the UCX schema may include the UCX file, the data block, data, and a tag. The UCX file refers to a file structure or a file object for informationizing user experience from each piece of the data. This data block is a collection in which data associated with each other in the UCX file is structured, and the data block may include each piece of the data as well as the data block itself. Data, which is a basic element forming user experience, may be included in the UCX file or the data block. The tag, which is additional information for describing data, may include additional information such as an occurrence time, location, an attribute, and the like of data.

Meanwhile, the UCX file, the data block, and the data may have a unique identifier, as well. A UCX file identifier may be a unique URL address capable of providing a unique identification means. The data block and data may also have an identifier capable of being identified in the UCX file such as a name of the data block or data, or the like. Each piece of the data may be identified on a web by combining the identifier of the UCX file, the identifier of the data block, and data identifier.

Referring to FIG. 3, it may be appreciated that the data blocks such as ‘VEHICLE’, ‘PERSON’, ‘ENVIRONMENT’, ‘WINDOW’ and the like are included in the UCX file. In addition, the UCX file may include a unique URL 310 capable of identifying the UCX file. In addition, the data block ‘WINDOW’ may include a data block identifier 320 therein, and may include sub-data blocks such as ‘FRONT LEFT’, ‘REAR RIGHT’, and the like. In addition, a data block ‘REAR RIGHT’ may include each piece of data of ‘position-1’ to ‘position-n’. Each piece of data of ‘position-1’ to ‘position-n’ may include a tag indicating information such as an occurrence time, a location, and the like of data.

The UCX schema having the combinable structure described in FIG. 3 may continuously expand a kind and structure of the data block, and a kind of data included in the data block depending on the purpose for combining with other UCX schemas.

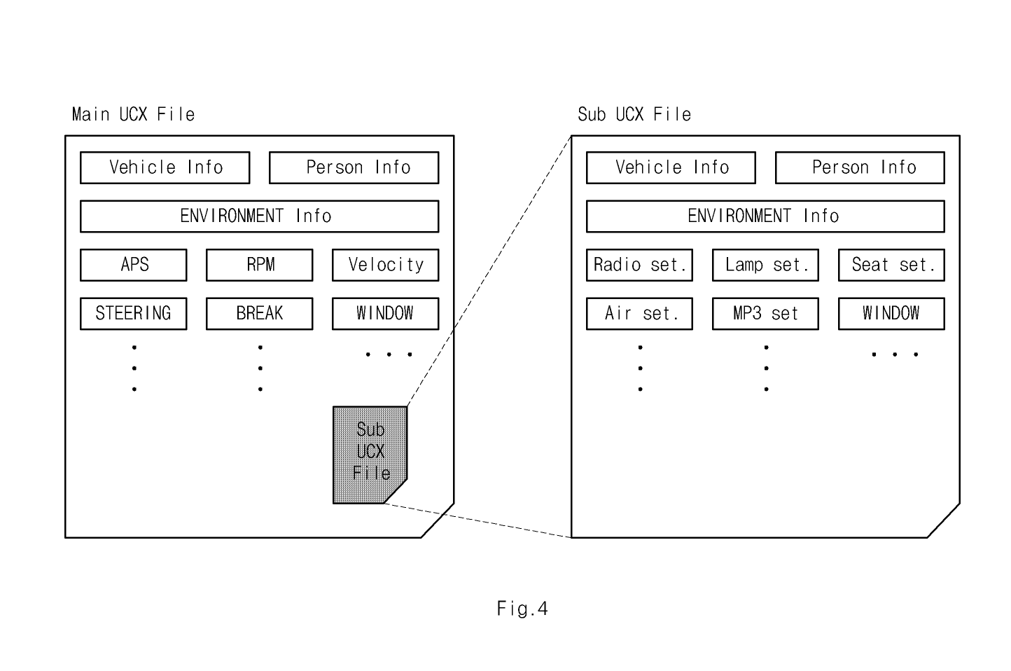

Meanwhile, the plurality of UCX files may be combined to each other by various methods. For example, the UCX file may be directly inserted into other UCX files or may be inserted as a reference form by inserting identification information. In addition, the UCX file itself may be inserted into other UCX files, or the data block included in the UCX file may be inserted into other UCX files. Hereinafter, a form to which the UCX file is combined will be described in detail with reference to FIGS. 4 to 7. When describing the combined form of the UCX file with reference to FIGS. 4 to 7, one of the plurality of UCX files will be described as a main UCX file, and the other will be described as a sub UCX file, respectively.

FIGS. 4 to 6 are views for describing a combined form of UCX files according to an exemplary embodiment of the present invention. Referring to FIG. 4, the sub UCX file itself may be included in the main UCX file. That is, the sub UCX file itself may be included in the main UCX file as one data block.

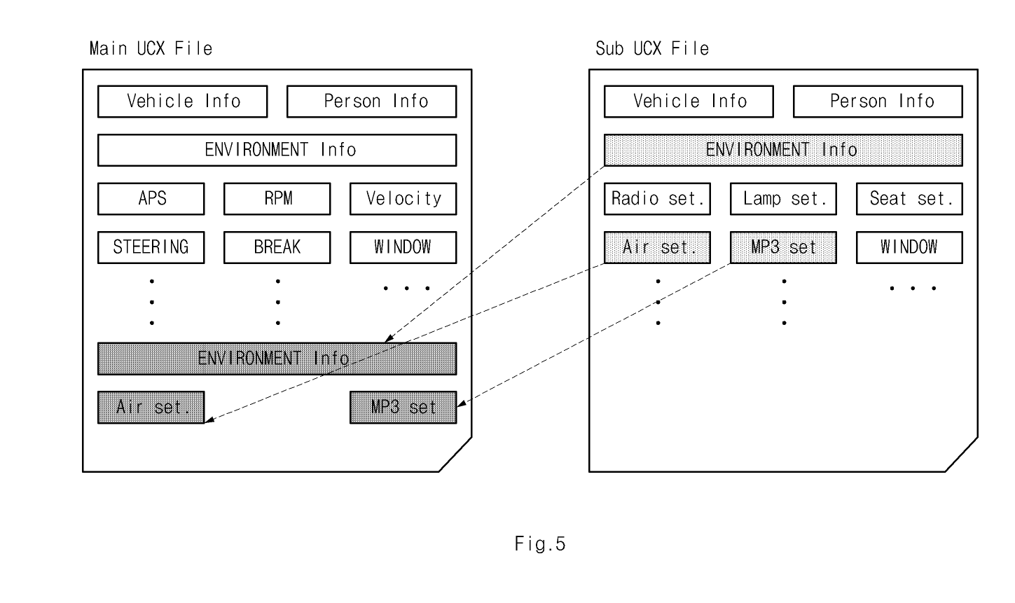

Referring to FIG. 5, a data block unit forming the sub UCX file may be included in the main UCX file. In this case, all of the data blocks of the sub UCX file need not be included in the main UCX file, and only the data block required for the purpose of combining may be included in the main UCX file. In FIG. 5, the data blocks ‘ENVIRONMENT INFO’, ‘AIR SET’, and ‘MP3 SET’ may be included in the main UCX file.

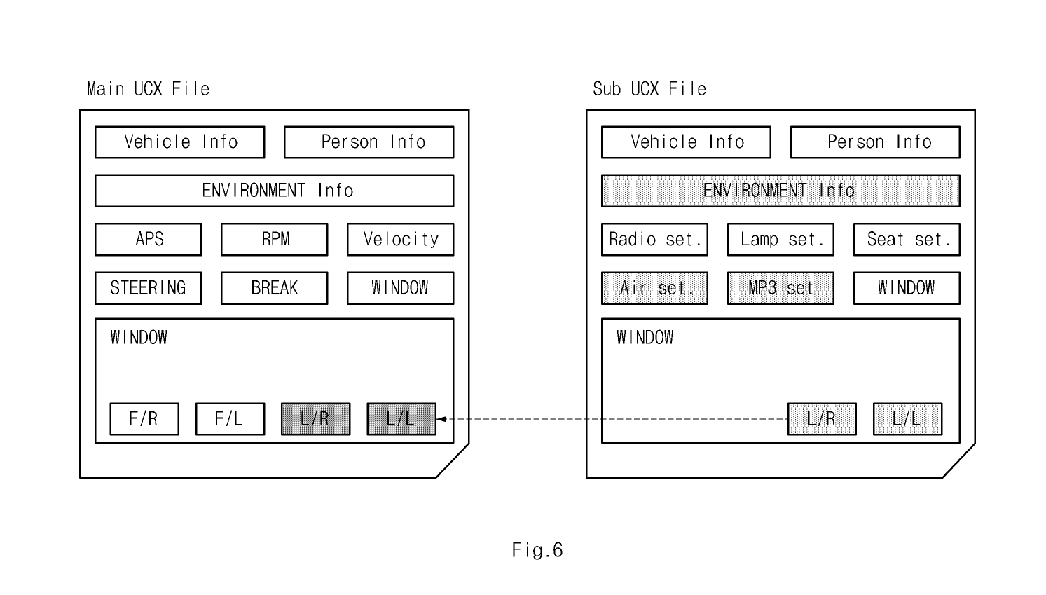

Referring to FIG. 6, a data unit forming the sub UCX file may be included in the main UCX file. Data in data blocks ‘L/R’ and ‘L/L’ included in the data block ‘WINDOW’ of the sub UCX file of FIG. 6 may be inserted into data blocks ‘L/R’ and ‘L/L’ included in the data block ‘WINDOW’ of the main UCX file. The combination of the data units may be implemented when the same data block is in the main UCX file and the sub UCX file as shown in FIG. 6. In this case, all data included in the data blocks ‘L/R’ and ‘L/L’ of the sub UCX file need not to be included in the data blocks ‘L/R’ and ‘L/L’ of the main UCX file, and a part thereof may be included.

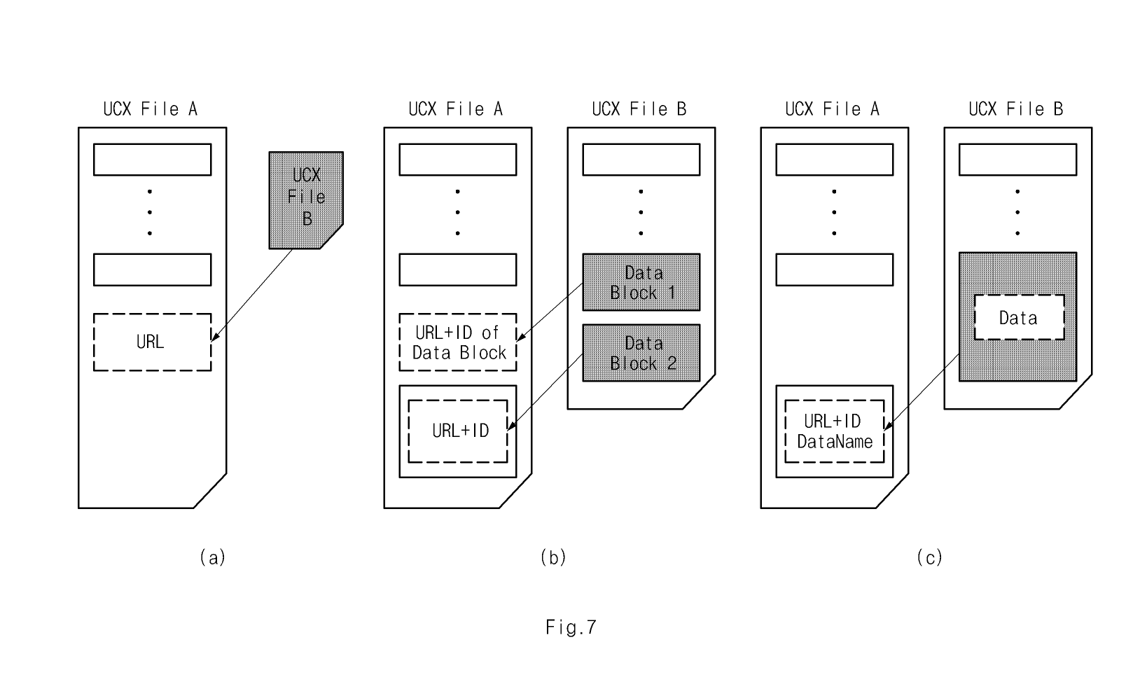

Meanwhile, since the UCX file, the data block, and data have the unique identifier as described above, even though the sub UCX file (or, the data block and data) is directly combined to the main UCX file, the plurality of UCX files may be combined by inserting an identifier capable of identifying the UCX file (or, the data block and data) into a combination location. This will be described in detail with reference to FIGS. 7A to 7C.

FIGS. 7A to 7C are views for describing combined forms of UCX files according to another exemplary embodiment of the present invention. Referring to FIG. 7A, when the sub UCX file itself is combined with the main UCX file, a URL address of the sub UCX file (UCX file B) may be inserted into the main UCX file (UCX file A). Since the URL address of the sub UCX file is the unique identifier identifying the sub UCX file, when the combined UCX file is interpreted later, the sub UCX file may be loaded using the URL address of the sub UCX file.

In addition, referring to FIG. 7B, when the data block of the sub UCX file is combined with the main UCX file, the URL address of the sub UCX file and the identifier of the data block may be inserted into the main UCX file. Since the URL address of the sub UCX file may specific the sub UCX file and the identifier of the data block may specific the data block in the sub UCX file as described above, when the combined UCX file is interpreted later, the specific data block included in the sub UCX file may be loaded using the URL address of the sub UCX file and the identifier of the data block.

Referring to FIG. 7C, when data of the sub UCX file is combined with the main UCX file, the URL address of the sub UCX file, the identifier of the data block, and the data identifier may be inserted into the main UCX file. As the data identifier, a data name may be used. Thereafter, when combined UCX file is interpreted, specific data included in the specific data block in the sub UCX file may be loaded using the URL address of the sub UCX file, the identifier of the data block, and the data identifier.

Meanwhile, the UCX combiner 130 may tag information indicating a source to data (or the data block) forming the plurality of UCX files. That is, the UCX combiner 130 may tag information capable of identifying whether data forming the UCX file corresponds to any UCX file. In addition, the UCX combiner 130 may check whether or not the combination may be substantially implemented when the new UCX file is created according combination information. When a plurality of UCX files are created based on the UCX schemas different from each other, uncombinable data may be present, and this may be determined in advance before creating a substantially combined UCX file.

The UCX creator 140 creates the UCX file. The UCX creator 140 creates a new UCX file by combining the plurality of UCX files according to combination information created by the UCX creator 130. Specifically, the UCX creator 140 may request a UCX creating plug-in to the outside through the communication interface 170 and may create the new UCX file having the plurality of UCX files combined therewith using the UCX creating plug-in. The UCX creating plug-in may be installed and removed as an application module implementing a file creating algorithm according to a preset rule.

As described above, the UCX file may have different UCX schemas depending on its purpose, and the UCX creating plug-in may also separately be present according to the UCX schemas. Therefore, the UCX creator 140 may select the UCX creating plug-in corresponding to each UCX file when combining the plurality of UCX files according to combination information. Specifically, the UCX creator 140 may select the UCX creating plug-in using source information tagged to each data or data block at the UCX combiner 130.

Meanwhile, the UCX creator 140 may create the UCX file by organically combining data collected by the vehicle data collector 110. Here, the UCX creator 140 may create the UCX file by combining the respective data collected using the UCX creating plug-in received through the communication interface 170. The UCX creator 140 may create an edited UCX file based on edited information created by the UCX editor 150. The UCX creator 140 may create the edited UCX file using the UCX creating plug-in. This UCX creator 140 may insert a tag or meta data for at least one of time, location, and/or relationship into the respective data or data blocks forming the UCX file, when creating the UCX file.

The UCX editor 150 may then create edited information according to user instructions input through the user interface 180. Edited information may include information for removal, variation, and addition of data or the data blocks forming the UCX file.

The storing unit 160 (e.g., memory, a hard drive or the like) stores the UCX file created by the UCX creator 140 and the UCX file received from the outside through the communication interface 170. In this case, the storing unit 160 may classify and store the UCX file according to an attribute, a layer, and the like of the corresponding file. In addition, the storing unit 160 may provide the stored UCX file to the UCX interpreter 120 or the outside.

The communication interface 170 (e.g., a network adaptor) connects the system 100 to outside sources (e.g., other vehicles, the terminal apparatus, the server, and the like) to thereby transmit and receive the UCX file. As such, the communication interface 170 may receive the UCX creating plug-in and the UCX interpreting plug-in and may transmit a message that the UCX file is converted into an executable form in the message converter 190 to the outside or may provide the message to various controlling apparatuses.

The user interface 180 may then provide a result that the UCX interpreter 120 interprets the UCX file to the user. The user interface 180 may provide the interpreted result of the UCX file on a display screen in a form of GUI for convenience for the user. In addition, the user interface 180 may receive instructions for creating, combining, and editing the UCX file from the user. To this end, the user interface may include a display unit (not shown), an inputting unit (not shown), and a GUI creator (not shown).

The message converter 190 converts the message into a form which may be executed outside based on the interpreted result of the UCX file of the UCX interpreter 120. Specifically, the message converter 190 may convert the interpreted result of the UCX file into a message having forms such as a control signal, display information, an operation result, and the like. The converted message converted by the message converter 190 may be transmitted to the outside or the controlling apparatus of the vehicle through the communication interface 170.

The XML parser 195 may be configured to analyze the tag inserted into the UCX file to thereby provide to the UCX interpreter 120 and the UCX combiner 130.

According to the above described exemplary embodiments, when the plurality of UCX files having the file formats different from each other are combined, the plurality of UCX files may be combined using only the existing UCX creation plug-in without using the new plug-in, and even when the combined UCX file is utilized, the UCX file may be utilized using only the existing UCX creation plug-in without using the new plug-in. In addition, the user may easily combine the UCX file to be matched to the user's purpose by providing the structure and the combined state of the UCX file.

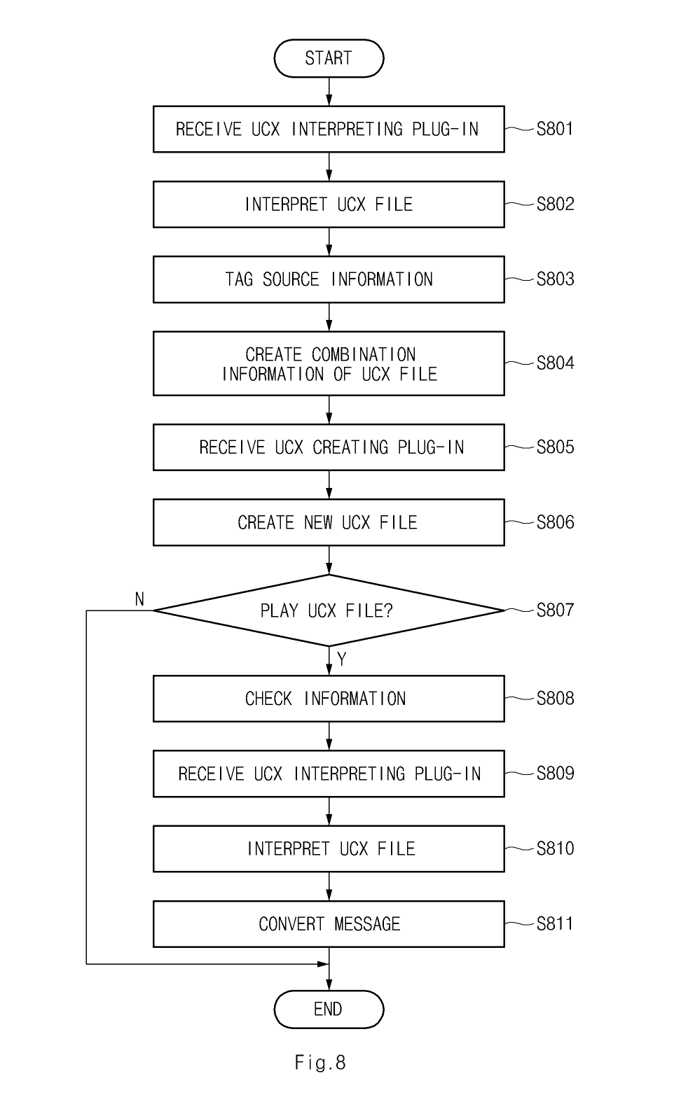

FIG. 8 is a flow chart for describing an experience information managing method according to an exemplary embodiment of the present invention. Particularly, FIG. 8 is to describe a method of combining and playing the plurality of UCX files. Referring to FIG. 8, when a plurality of files are input, a UCX interpreting plug-in is received (S801). In the case in which the plurality of UCX files have file formats (UCX schemas) different from each other, the UCX interpreting plug-in for interpreting the UCX files may be each received. In addition, a structure of the plurality of UCX files is interpreted using the UCX interpreting plug-in (S802).

Thereafter, information indicating a source is tagged to data forming the plurality of UCX files (S803). In addition, combination information of the plurality of UCX files is created (S804). In addition, a UCX creating plug-in corresponding to each of the UCX files is received using tagging information (S805). When the UCX creating plug-in is received, a new UCX file is created according to combination information (S806).

Next, when a playing event for the combined UCX file is generated (S807-Y), information indicating the source tagged to each data in the combined UCX file is checked (S808). In addition, the UCX interpreting plug-in corresponding to each data is received using tagging information (S809). When the UCX interpreting plug-in is received, a structure of the combined UCX file is interpreted using the UCX interpreting plug-in (S810). In addition, a message is converted into a form which may be executed outside based on an interpreted result (S811).

According to the exemplary embodiments of the present invention, when the plurality of UCX files having the file formats different from each other are combined, the plurality of UCX files may be combined using only the existing UCX creation plug-in without using the new plug-in, and even when the combined UCX file is played, the UCX file may be played using only the existing UCX creation plug-in without using the new plug-in. In addition, the user may easily combine the UCX file to be matched to the user's purpose by being providing with the structure and the combined state of the UCX file.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An experience information managing apparatus, comprising:
one or more network interfaces adapted to communicate in a vehicle;
a processor adapted to execute one or more processes; and
a memory configured to store a process executable by the processor, the process when executed operable to:
interpret structures of a first and second user created experience UCX file when the first UCX file and the second UCX file have a file format different from each other are input;
tag information indicating a source to data forming the first and second UCX files;
create combination information from the first and second UCX files; and
create a third UCX file having the first and second UCX files combined therewith according to the combination information.

2. The apparatus according to claim 1, wherein the UCX files are content files including metadata for experience information of a driver and a vehicle created by combining manipulation data of the vehicle by the driver and data obtained from the vehicle and around the vehicle in response to the manipulation data.

3. The apparatus according to claim 1, wherein the first, second and third UCX files are prepared with a meta script language.

4. The apparatus according to claim 1, wherein the network adaptor is configured to receive first and second UCX interpreting plug-ins implementing an interpreting algorithm for a data structure of each of the first and second UCX files,
wherein the processor interprets the structures of the first and second UCX files using the first and second UCX interpreting plug-ins.

5. The apparatus according to claim 1, wherein the processor combines the first and second UCX files by directly inserting data forming the first UCX file into the second UCX file or inserting identification information of data forming the first UCX file into the second UCX file.

6. The apparatus according to claim 1, wherein the network adaptor is configured to receive first and second UCX creating plug-ins implementing a file creating algorithm for each of the first and second UCX files,
wherein the processor creates a new UCX file using the first and second UCX creating plug-ins.

7. An experience information managing method, comprising:
interpreting, by a processor, structures of first and second user created experience (UCX) files when the second UCX file having a file format different from that of the first UCX file is input;
tagging, by the processor, information indicating a source to data forming the first and second UCX files;
creating, by the processor, combination information of the first and second UCX files; and
creating, by the processor, a third UCX file having the first and second UCX files combined therewith according to the combination information.

8. The method according to claim 7, wherein the interpreting of the structures includes:
receiving first and second UCX interpreting plug-ins implementing an interpreting algorithm for a data structure of each of the first and second UCX files; and
interpreting the structure of each of the first and second UCX files using the first and second interpreting plug-ins.

9. The method according to claim 7, wherein the creating of the third UCX file includes:
receiving first and second UCX creating plug-ins implementing a file creating algorithm for each of the first and second UCX files using the tagging information; and
creating a new UCX file using the first and second UCX creating plug-ins.

10. A non-transitory computer readable medium containing program instructions executed by a processor or controller, the computer readable medium comprising:
program instructions that interpret structures of first and second user created experience (UCX) files when the second UCX file having a file format different from that of the first UCX file is input;
program instructions that tag information indicating a source to data forming the first and second UCX files;
program instructions that create combination information of the first and second UCX files; and
program instructions that create a third UCX file having the first and second UCX files combined therewith according to the combination information.

11. The non-transitory computer readable medium according to claim 10, wherein the interpreting of the structures includes:
program instructions that receive first and second UCX interpreting plug-ins implementing an interpreting algorithm for a data structure of each of the first and second UCX files; and
program instructions that interpret the structure of each of the first and second UCX files using the first and second interpreting plug-ins.

12. The non-transitory computer readable medium according to claim 10, wherein the creating of the third UCX file includes:
program instructions that receive first and second UCX creating plug-ins implementing a file creating algorithm for each of the first and second UCX files using the tagging information; and
program instructions that create a new UCX file using the first and second UCX creating plug-ins.
